(19) United States
(12) Patent Application Publication
(10) Pub. No.: US 2008/0012799 A1
(43) Pub. Date: Jan. 17, 2008

(54) Plasma display and driving method thereof

(76) Inventor: Ki-Hyung Park, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/730,112

(22) Filed: Mar. 29, 2007

(30) Foreign Application Priority Data
Apr. 28, 2006 (KR) 10-2006-0038680

(51) Int. Cl. G09G 3/28

(52) U.S. Cl. 345/68

(57) ABSTRACT

A plasma display is driven by dividing a plurality of row electrodes into a first row group and a second row group of row electrodes, dividing the first row group of row electrodes into a plurality of first subgroups, and dividing the second row group of row electrodes into a plurality of second subgroups. During a first address period of each first subgroup, non-light emitting cells are selected from among the first subgroup of discharge cells, and at least one second subgroup of light emitting cells among the plurality of second subgroups are sustain-discharged. In addition, during a second address period of each second subgroup, non-light emitting cells are selected from among each second subgroup of light emitting cells and at least one first subgroup of light emitting cells are sustain-discharged. During a first period consecutive to the first address period, a reference voltage is applied to the plurality of column electrodes and the at least one second subgroup is sustain-discharged, and during a second period consecutive to the second address period, the reference voltage is applied to the plurality of column electrodes and the at least one first subgroup is sustain-discharged.

### BACKGROUND OF THE INVENTION

1. Field of the Invention

The present invention relates to a plasma display device and a driving method thereof.

2. Description of the Related Art

A plasma display device is a flat panel display that includes a plurality of discharge cells, in which plasma generated by a gas discharge process is used to display characters or images. A field (e.g., 1 TV field) used for display may be divided into a plurality of subfields, each having a respective weight. Each subfield may include an address period, in which an address operation for selecting discharge cells to emit light and discharge cells to not emit light from among a plurality of discharge cells, and a sustain period, in which a sustain discharge occurs in the selected discharge cells to perform a display operation during a period corresponding to the weight of the subfield.

Such a plasma display device uses subfields having different weight values to express grayscales. A grayscale of the corresponding discharge cell is expressed by a total of the weight values of subfields in which the discharge cell emits light among the plurality of subfields. An observer will integrate the subfields over a field to view the correct grayscale. However, when similar grayscales in consecutive fields have much different subfield arrangements, a false contour (dynamic false contour) may occur. For example, when the subfields with weights in the format of a power of 2 are used, a false contour (dynamic false contour) may occur when a discharge cell expresses the grayscales of 127 and 128, i.e., when the subfield arrangement changes from seven of the eight subfields being used to only the eighth subfield being used, in two consecutive fields.

In addition, when address and sustain periods are separated with a predetermined interval therebetween, the length of one subfield becomes longer because respective subfields have additional address periods for addressing all the discharge cells. As a result, the number of subfields available in one field is reduced.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a plasma display and a driving method thereof, which substantially overcomes one or more of the problems due to the limitations and disadvantages of the related art.

It is a feature of an embodiment of the present invention to reduce a false contour.

It is another feature of an embodiment of the present invention to reduce a subfield length.

It is yet another feature of an embodiment of the present invention to generate a stable erase discharge.

At least one of the above and other features and advantages of the present invention may be realized by providing a method for driving a plasma display device having a plurality of row electrodes and a plurality of column electrodes, and a plurality of discharge cells defined by the plurality of row and column electrodes, wherein one field is divided into a plurality of subfields. The driving method includes, at each of a plurality of first subfields consecutive to each other among the plurality of subfields, dividing the plurality of row electrodes into a first row group and a second row group of row electrodes, dividing the first row group of row electrodes into a plurality of first subgroups, and dividing the second row group of row electrodes into a plurality of second subgroups, during a first address period of each first subgroup, selecting non-light emitting cells from among the first subgroup of light emitting cells and sustain-discharging at least one second subgroup of light emitting cells from among the plurality of second subgroups, during a first period consecutive to the first address period, applying a first voltage to the plurality of column electrodes and sustain-discharging the at least one second subgroup of light emitting cells, during a second address period of each second subgroup, selecting non-light emitting cells among each second subgroup of light emitting cells and sustain-discharging at least one first subgroup of light emitting cells among the plurality of first subgroups, and during a second period consecutive to the second address period, applying the first voltage to the plurality of column electrodes and sustain-discharging the at least one first subgroup of light emitting cells.

At least one of the above and other features and advantages of the present invention may be realized by providing a plasma display including a plasma display panel including a plurality of row electrodes, a plurality of column electrodes, and a plurality of discharge cells respectively defined by the first and second electrodes; a controller for dividing one field into a plurality of subfields, dividing the plurality of row electrodes into first and second row groups, dividing the first row group of column electrodes into a plurality of first subgroups, and dividing the second column group of column electrodes into a plurality of second subgroups; and a driver for driving the plurality of row electrodes and the plurality of column electrodes. At each of the plurality of consecutive first subfields, the driver sequentially applies a scan pulse to each first subgroup of the plurality of row electrodes during a second period among a first period of each first subgroup and sustain-discharges at least one second subgroup of light emitting cells among the plurality of second subgroups, during a third period among the first period, the driver applies a voltage higher-than that of the scan pulse to each first subgroup of the plurality of row electrodes and sustain-discharges at least one second subgroup of light emitting cells among the plurality of second subgroups, during a fifth period among a fourth period of each second subgroup, the fifth period being between the first periods, the driver sequentially applies a scan pulse to each second subgroup of the plurality of row electrodes and sustain-discharges at least one first subgroup of light emitting cells among the plurality of the first subgroups, and during a sixth period among the fifth period, the driver applies a voltage higher than that of the scan pulse to each second subgroup of the plurality of row electrodes and sustain-discharges at least one first subgroup of light emitting cells among the plurality of first subgroups.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic diagram of a plasma display device according to an embodiment of the present invention;

FIG. 2 illustrates a diagram of a grouping method of the respective electrodes used in a driving method of a plasma display device according to an exemplary embodiment of the present invention;

FIG. 3 illustrates a schematic diagram of a driving method of a plasma display device according to a first exemplary embodiment of the present invention;

FIG. 4 illustrates a driving method of FIG. 3 using only subfields;

FIG. 5 illustrates a driving waveform diagram of a plasma display device according to a driving method of FIG. 3;

FIG. 6 illustrates another driving waveform diagram of a plasma display device from the driving waveform of FIG. 5; and

FIG. 7 illustrates a schematic diagram of a driving method of a plasma display device according to a second exemplary embodiment of the present invention.

### DETAILED DESCRIPTION OF THE INVENTION

Korean Patent Application No. 10-2006-0038680 filed on Apr. 28, 2006, in the Korean Intellectual Property Office and entitled: “Plasma Display and Driving Method Thereof,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

To clarify the present invention, parts that are not described in the specification are omitted, and parts for which similar descriptions are provided have the same reference numerals.

In addition, throughout this specification and the claims that follow, unless explicitly described to the contrary, the word “comprise” or variations such as “comprises” or “comprising” will be understood to imply the inclusion of stated elements but not the exclusion of any other elements.

In addition, wall charges mentioned in the following description mean charges formed and accumulated on a wall (e.g., a dielectric layer) close to an electrode of a discharge cell.

A wall charge will be described as being “formed” or “accumulated” on the electrode, although the wall charges do not actually touch the electrodes. Further, “a wall voltage” means a potential difference formed on the wall of the discharge cell by the wall charge.

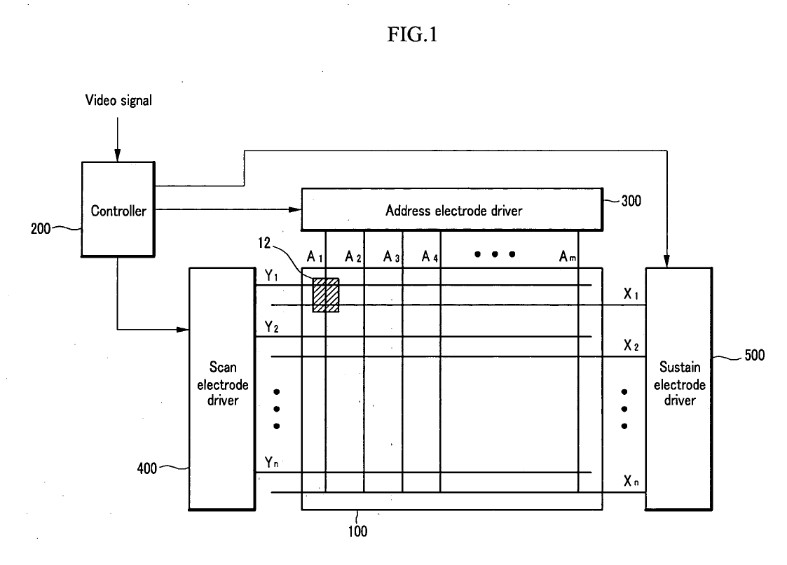

A plasma display device according to an exemplary embodiment of the present invention will now be described with reference to FIG. 1.

FIG. 1 illustrates a schematic diagram representing a plasma display device according to the exemplary embodiment of the present invention.

As shown in FIG. 1, the plasma display device according to the exemplary embodiment of the present invention may include a plasma display panel (PDP) 100, a controller 200, an address electrode driver 300, a scan electrode driver 400, and a sustain electrode driver 500.

The PDP 100 may include a plurality of address electrodes A₁ to Aₘ (hereinafter referred to as “A electrodes”) extending in a column direction, and a plurality of sustain and scan electrodes X₁ to Xₙ and Y₁ to Yₙ (hereinafter respectively referred to as “X electrodes” and “Y electrodes”) extending in a row direction by pairs. The X electrodes X₁ to Xₙ may be formed in correspondence to the Y electrodes Y₁ to Yₙ and a display operation may be performed by the X and Y electrodes during the sustain period. The Y and X electrodes Y₁ to Yₙ and X₁ to Xₙ may be perpendicular to the A electrodes A₁ to Aₘ. Here, a discharge space formed at an area where the A electrodes A₁ to Aₘ cross the X and Y electrodes X₁ to Xₙ and Y₁ to Yₙ forms a discharge cell 12. The configuration of the PDP 100 shown in FIG. 1 is an example, and other exemplary configurations may be applied in the present invention. Hereinafter, the X and Y electrodes extending by pairs in a row direction are referred to as row electrodes, and the A electrodes extending in a column direction are referred to as column electrodes.

The controller 200 may output X, Y, and A electrode driving control signals after receiving an external image signal. In addition, the controller 200 may drive the plasma display device by dividing a frame into a plurality of subfields, and may control the plasma display device by dividing the plurality of row electrodes into first and second row groups, and the first and second row groups into a plurality of respective subgroups.

The address electrode driver 300 receives the address electrode driving control signal from the controller 200, and applies a display data signal for selecting a discharge cell to be discharged to each respective address electrode A. The scan electrode driver 400 receives the scan electrode driving control signal from the controller 200, and applies the driving voltage to the scan electrode Y. The sustain electrode driver 500 receives the sustain electrode driving control signal from the controller 200, and applies the driving voltage to the sustain electrode X.

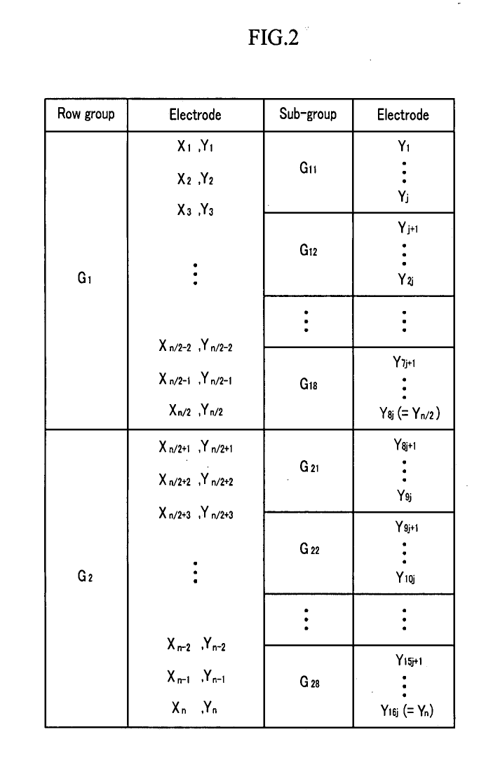

Referring to FIG. 2, a driving method of the plasma display device according to the exemplary embodiment of the present invention will now be described in more detail. FIG. 2 illustrates a method for grouping the respective electrodes used in a driving method of a plasma display device according to an exemplary embodiment of the present invention.

As shown in FIG. 2, one field may include two row groups, i.e., first and second row groups G₁ and G₂, into which the plurality of row electrodes X₁ to Xₙ and Y₁ to Yₙ may be divided. In the particular configuration illustrated in FIG. 2, the first row group G₁ may include a plurality of X electrodes X₁ to X_{n/2} and a plurality of Y electrodes Y₁ to Y_{n/2} in an upper portion of the PDP 100, and the second row group G₂ may include a plurality of X electrodes X_{(n/2)+1} to Xₙ and a plurality of Y electrodes Y_{(n/2)+1} to Yₙ in a lower portion of the PDP 100. Alternatively, the first row group G₁ may include even-numbered row electrodes and the second row group G₂ may include odd-numbered row electrodes.

In addition, the plurality of Y electrodes of the first and second row groups G₁ and G₂ respectively may again be divided into the plurality of subgroups G₁₁ to G₁₈ and G₂₁ to G₂₈. In the particular configuration illustrated in FIG. 2, the first and second row groups G₁ and G2 are respectively divided into eight subgroups G₁₁ to G₁₈ and G₂₁ to G₂₈.

In particular, in the first row group G₁, first to j-th Y electrodes Y₁ to Yⱼ are grouped into a first subgroup G11, and (j+1)-th to 2j-th Y electrodes Yⱼ₊₁ to Y₂ⱼ are grouped into a second subgroup G12. In such a manner, (7j+1)-th to (n/2)-th Y electrodes Y₇ⱼ₊₁ to Y_{n/2} are grouped into an eighth subgroup G₈ (here, j is an integer between 1 and n/16). Likewise, in the second row group G₂, (8j+1)-th to 9j-th Y electrodes Y₈ⱼ₊₁ to Y₉ⱼ are grouped into a first subgroup G₂₁, and (9j+1)-th to 10j-th Y electrodes Y₉ⱼ₊₁ to Y₁₀ⱼ are grouped into a second subgroup G₂₂. In such a manner, (15j+1)-th to n-th Y electrodes Y₁₅ⱼ₊₁ to Yₙ are grouped into an eighth subgroup G₂₈. Alternatively, Y electrodes spaced at a predetermined interval or at irregular intervals in the first and second row groups G1 and G2 may be grouped into a respective subgroup.

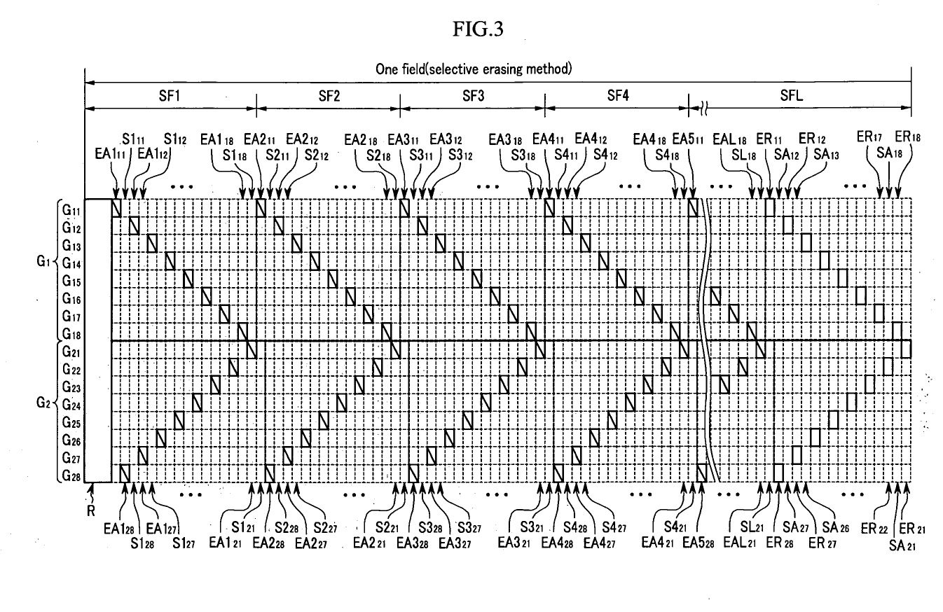

FIG. 3 illustrates a driving method of a plasma display device according to a first exemplary embodiment of the present invention. In FIG. 3, first to L-th subfields SF1 to SFL are illustrated with reference to the first row group G₁.

Referring to FIG. 3, one field may include a plurality of subfields SF1 to SFL. In this particular example, the first to L-th subfields SF1 to SFL respectively include address periods EA1₁₁ to EAL₁₈ and EA1₂₁ to EAL₂₈, and sustain periods S1₁₁ to SL₁₈ and S1₂₁ to SL₂₈. As described with reference to FIG. 2, the plurality of row electrodes X₁ to Xₙ and Y₁ to Yₙ may be divided into the first and second row groups G₁ and G₂, and the first and second row groups G₁ and G₂ may be respectively divided into a plurality of subgroups G₁₁ to G₁₈ and G₂₁ to G₂₈.

A selective erase method and a selective write method may be used to select discharge cells to emit light (hereinafter, called “light emitting cells”) and discharge cells to not emit light (hereinafter, called “non-light emitting cells”) among the plurality of discharge cells. The selective write method selects a light emitting cell and forms a substantially constant wall voltage on the same. The selective erase method selects a non-light emitting cell and erases the formed wall voltage from the same. That is, the selective write method address discharges cells in a non-light emitting state, forms a wall charge, and sets them to be light emitting cells. The selective erase method address discharges cells in a light emitting state, erases the formed wall charges, and sets them to be non-light emitting cells. Hereinafter, the address discharge for forming the wall charges in the selective write method will be referred to as a “write discharge,” and the address discharge for erasing the wall charges in the selective erase method will be referred to as an “erase discharge.”

Referring to FIG. 3, when the selective erase method is to be used to address the discharge cells, a reset period R may be provided immediately before the address period EA₁₁ of the first subfield SF1 provided foremost among the first to L-th subfields SF1 to SFL having the address periods EA1₁₁ to EAL₁₈ and EA1₂₁ to EAL₂₈, such that all the discharge cells are initialized and set in the light emitting cell state by the reset period R. That is, all the discharge cells may be initialized and set in the light emitting state during the reset period R, and may be set in a cell state that is capable of being erased during the address periods EA1₁₁ to EAL₁₈ and EA1₂₁ to EAL₂₈.

In the first subfield SF1, the address periods EA1₁₁ to EAL₁₈ and EA1₂₁ to EAL₂₈ and sustain periods S1₁₁ to SL₁₈ and S1₂₁ to SL₂₈ may be sequentially performed for the respective first to eighth subgroups G₁₁ to G₁₈ and G₂₁ to G₂₈ of the first and second row group G₁ and G₂. In the same manner as in the first subfield SF1, address periods EA2₁₁ to EAL₁₈ and EA2₂₁ to EAL₂₈ and sustain periods S2₁₁ to SL₁₈ and S2₂₁ to SL₂₈ of other subfields SF2 to SFL may be sequentially performed. Since operations of address periods EA1₁₁ to EAL₁₈ and EA1₂₁ to EAL₂₈ and sustain periods S1₁₁ to SL₁₈ and S1₂₁ to SL₂₈ of each subfield SF1 to SFL are substantially the same, operations of address periods EAk₁₁ to EAk₁₈ and EAk₂₁ to EAk₂₈ and sustain periods Sk₁₁ to Sk₁₈ and Sk₂₁ to Sk₂₈ of a k-th subfield SFk will be described (k is an integer between 1 and L).

At the k-th subfield SFk of the first row group G₁, an address period EAk₁ᵢ of an i-th subgroup G₁ᵢ is performed and then a sustain period Sk₁ᵢ of the i-th subgroup G₁ᵢ is performed (herein, i is an integer between 1 and 8). An address period EAk₁₍ᵢ₊₁₎ and a sustain period Sk₁₍ᵢ₊₁₎ of an (i+1)-th subgroup G₁₍ᵢ₊₁₎ may be consecutively performed. At the k-th subfield SFk of the second row group G₂, an address period EAk₂₍ᵢ₊₁₎ of an (i+1)-th subgroup G₂₍ᵢ₊₁₎ is performed and then a sustain period Sk₂₍ᵢ₊₁₎ of an (i+1)-th subgroup G₂₍ᵢ₊₁₎ is performed. Next, an address period EAk₂ᵢ and a sustain period Sk₂ᵢ of an i-th group G₂ᵢ are performed. When the sustain period Sk₁ᵢ of the i-th subgroup G₁ᵢ of the first row group G₁ is performed at the k-th subfield SFk, an address period EAk₂₍₈₍ᵢ₋₁₎₎ of an (8-(i−1))-th subgroup G₂₍₈₋ᵢ₋₁₎₎ of the second row group G₂ may be performed. When the sustain period Sk₂₍₈₋₍ᵢ₋₁₎₎ of the (8-(i−1))-th subgroup G₂₍₈₋₍ᵢ₋₁₎₎ of the second row group G₂ is performed at the k subfield SFk, the address period EAk₁₍ᵢ₊₁₎ of the (i+1)-th subgroup G₁₍ᵢ₊₁₎ of the first row group G₁ may be performed.

In FIG. 3, at the second row group G₂, the address periods EAk₂₈ to EAk₂₁ and sustain periods Sk₂₈ to Sk₂₁ are sequentially performed from the eighth subgroup G₂₈ to the first subgroup G₂₁ in the second row group G₂. Alternatively, in the second row group G₂, the address periods EAk₂₁ to EAk₂₈ and sustain periods Sk₂₁ to Sk₂₈ may be subsequently performed from the first subgroup G₂₁ to the eighth subgroup G₂₈ in the same manner as in the first row group G₁. In addition, in the first and the second row groups G₁ and G₂, the address and sustain periods may be performed in a different sequence from that shown in FIG. 3.

In further detail regarding the respective subfields SF1 to SFL of the first row group G₁, cells to be set as non-light emitting cells from among the light emitting cells of the first subgroup G₁₁ are erase discharged to erase the wall charge in the address period EAk₁₁ of the first subgroup G₁₁ in the k-th subfield (SFk) of the first row group G₁, and other light emitting cells of the first subgroup G₁₁ are sustain discharged in the sustain period Sk₁₁. Discharge cells to be selected as a non-light emitting cells from among the light emitting cells of the second subgroup G₁₂ are erase discharged to erase the wall charge in the address period EAk₁₂ of the second subgroup G₁₂, and other light emitting cells of the second subgroup G₁₂ are sustain discharged in the sustain period Sk₁₂. In this instance, light emitting cells of the first subgroup G₁₁ are sustain discharged. In a like manner, the address periods EAk₁₃ to EAk₁₈ and the sustain periods Sk₁₃ to Sk₁₈ may be performed for the other subgroups G₁₃ to G₁₈.

Thus, during the sustain period Sk₁ᵢ of the i-th subgroup G₁ᵢ, the light emitting cells of the i-th subgroup G₁ᵢ and the light emitting cells of the first to (i−1)-th subgroups G₁₁ to G₁₍ᵢ₋₁₎ and the (i+1) to eighth subgroups G₁₍ᵢ₊₁₎ to G₁₈ are sustain discharged. The light emitting cells of the first to (i−1)-th subgroups G₁₁ to G₁₍ᵢ₋₁₎ are light emitting cells at which no erase discharge is generated in the respective address periods EAk₁₁ to EAk₁₍ᵢ₋₁₎ of the k-th subfield SFk, and the light emitting cells of the (i+1)-th to eighth subgroups G₁₍ᵢ₊₁₎ to G₁₈ are light emitting cells at which no erase discharge is generated in the address periods EA₍ₖ₋₁₎₁₍ᵢ₊₁₎ to EA₍ₖ₋₁₎₁₈ of the (k−1)-th subfield SF(k−1). The light emitting cell of the i-th subgroup G₁ᵢ is sustain discharged up to the sustain period SK1(i−1) before the address period EA₍ₖ₊₁₎₁ᵢ of the i-th subgroup G₁ᵢ of the (k+1)-th subfield SF(k+1). That is, the light emitting cells of the i-th subgroup G₁ᵢ are sustain discharged during the eight sustain periods.

Accordingly, the address periods EA2₁₁ to EA2₁₈, . . . , and EAL₁₁ to EAL₁₈ and sustain periods S2₁₁ to S2₁₈, . . . , SL₁₁ to SL₁₈ are performed for the respective subgroups G₁₁ to G₁₈ of all the subfields SF1 to SFL. Therefore, the discharge cells that are set as light emitting cells during the reset period R consecutively perform a sustain discharge until the discharge cells are set to be non-light emitting cells by the erase discharges at the respective subfields SF1 to SFL. When the discharge cells are switched to non-light emitting cells by the erase discharges, these discharge cells are not sustain-discharged after the corresponding subfields. At this time, the respective subfields SF2 to SFL have weight values corresponding to a sum of the lengths of the eight sustain periods of the respective subfields SF2 to SFL.

When the sustain period SL₁₈ is performed in the last subfield SFL, the first subgroup G₁₁ is sustain discharged a total of eight times, the second subgroup G₁₂ is sustain discharged a total of seven times, and the third subgroup G₁₃ is sustain discharged a total of six times. The fourth subgroup G₁₄ is sustain discharged a total of five times, the fifth subgroup G₁₅ is sustain discharged a total of four times, and the sixth subgroup G₁₆ is sustain discharged a total of three times. In addition, the seventh subgroup G₁₇ is sustain discharged twice, and the eighth subgroup G₁₈ is sustain discharged once. Accordingly, the last subfield SFL of the first row group G₁ may have erase periods ER₁₁ to ER₁₇ and additional sustain periods SA₁₂ to SA₁₈ such that the number of sustain discharges of the first to eighth subgroups G₁₁ to G₁₈ are the same.

In detail, the first subgroup G₁₁ having undergone a total of eight sustain discharges just before the erase period ER₁₁ may not need an additional sustain discharge. Accordingly, the wall charges formed in all the discharge cells of the first subgroup G₁₁ may be erased during the erase period ER₁₁. Then, during the additional sustain period SA₁₂, the light emitting cells of the first to eighth subgroups G₁₁ to G₁₈ are sustain-discharged. At this time, since the wall charges formed in all the discharge cells of the first subgroup G₁₁ were erased during the erase period ER₁₁, during the additional sustain period SA₁₂, the light emitting cells of the second to eighth subgroups G₁₂ to G₁₈ are respectively sustain-discharged by one.

Since all the discharge cells of the second subgroup G₁₂ have undergone a total of eight sustain discharges due to the additional sustain period SA₁₂, the wall charges formed in all the discharge cells of the second subgroup G₁₂ may be erased during the erase period ER₁₂. During the additional sustain period SA₁₃, the light emitting cells of the first to eighth subgroups G₁₁ to G₁₈ are sustain-discharged. Since the wall charges formed in all the discharge cells of the first and second subgroups G₁₁ and G₁₂ were erased during the each erase period ER₁₁ and ER₁₂, during the additional sustain period SA₁₃, an additional sustain discharge is generated once in the light emitting cells of the third to eighth subgroups G₁₃ to G₁₈.

Since all the discharge cells of the third subgroup G₁₃ have undergone a total of eight sustain discharges due to the additional sustain period SA₁₃, the wall charges formed in all the discharge cells of the third subgroup G₁₃ may be erased during the erase period ER₁₃. During the additional sustain period SA₁₄, the light emitting cells of the first to eighth subgroups G₁₁ to G₁₈ are sustain-discharged. Since the wall charges formed in all the discharge cells of the first to third subgroups G₁₁ to G₁₃ were erased during the respective erase periods ER₁₁ to ER₁₃, during the additional sustain period SA₁₃, an additional sustain discharge is generated once in the light emitting cells of the fourth to eighth subgroups G₁₄ to G₁₈.

In a like manner, the number of sustain discharges of the first to eighth subgroups G₁₁ to G₁₈ may be the same when the erase periods ER₁₄ to ER₁₇ and the additional sustain periods SA₁₅ to SA₁₈ are performed.

An erase period ER₁₈ for erasing the wall charges of the eighth subgroup G₁₈ may be formed after the additional sustain period SA₁₈ of the eighth subgroup G₁₈. When the reset period R is to be performed at the first subfield SF1 of the next field, the erase period ER₁₈ of the eighth subgroup G₁₈ may be omitted. The erase operation of such erase periods ER₁₁ to ER₁₈ may be sequentially performed for the respective row electrodes of the respective subgroups as in the address period, and may be simultaneously performed for all the row electrodes of the respective row groups.

Regarding the respective subfields SF1 to SFL of the second row group G₂, the respective subfields SF1 to SFL of the second row group G₂ may have substantially the same structure as the respective subfields SF1 to SFL of the first row group G₁. As described above, at the respective subfields SF1 to SFL of the second row group G₂, the address periods EA1₂₈ to EA1₂₁, . . . , EAL₂₈ to EAL₂₁ are subsequently performed in the order of from the eighth subgroup G₂₈ to the first subgroup G₂₁, and also, the erase period ER₂₁ to ER₂₈ of the last subfields SFL of the second row group G₂ are subsequently performed in the order of from the eighth subgroup G₂₈ to the first subgroup G₂₁.

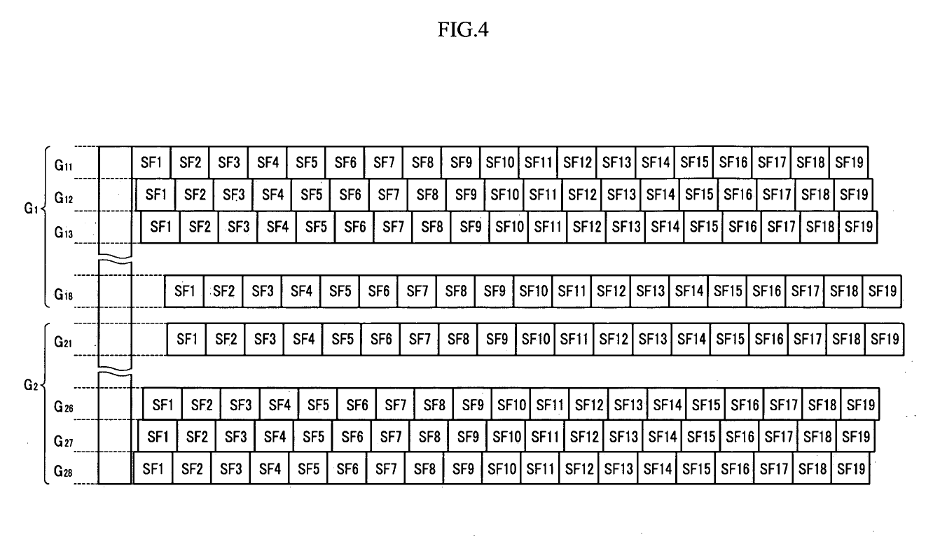

FIG. 4 illustrates the plasma display device driving method using the subfields. In FIG. 4, one field includes nineteen subfields SF1 to SF19. When the selective erase method is to be used for addressing the discharge cells, the subfields SF1 to SF19 may be shifted by a predetermined interval in the respective subgroups G₁₁ to G₁₈ and G₂₈ to G₂₁ of the first and second row groups G₁ to G₂. The predetermined interval may correspond to the length of the address period (EAk₁ᵢ or EAk₂ᵢ) of one subgroup (G₁ᵢ or G₂ᵢ) and the sustain period (Sk₁ᵢ or Sk₂ᵢ) of one subgroup (G₁ᵢ or G₂ᵢ). When it is assumed that the length of the address period (EAk₁ᵢ or EAk₂ⱼ) of one subgroup (G₁ᵢ or G₂ᵢ) corresponds to that of the sustain period (Sk₁ᵢ or Sk₂ⱼ) of one subgroup (G₁ᵢ or G₂ᵢ), starting points of the respective subfields SF1 to SF19 of the second row group G₂ may be shifted from the starting point of the respective subfields SF1 to SF19 of the first row group G₁ by the length of the address period (EAk₁ᵢ or EAk₂ᵢ).

Accordingly, the sustain period may be performed for the row electrodes of the second row group G₂ during the address period of the row electrodes of the first row group G₁, and the sustain period may be performed for the row electrodes of the second row group G₂ during the address period of the row electrodes of the first row group G₁. That is, the length of the one subfield may be reduced because the address and sustain periods are not separated, and the sustain period may be performed during the address period. In addition, since the priming particles formed during the sustain period are sufficiently used during the address period, in that the address periods are disposed between the sustain periods of the respective subgroups, the width of the scan pulse become shorter, thereby increasing the speed of the scan. Further, the contrast ratio may be increased, since no strong discharge is generated in the reset period.

No false contour occurs since the grayscale is expressed by consecutive subfields before an erase discharge is generated in the corresponding subfield from among a plurality of subfields SF1 to SF19, and discharge cells in a light emitting cell state are switched to a non-light emitting cell. The grayscales that are not expressed by the combination of weights of the respective subfield SF1 to SF19 may be expressed by dithering.

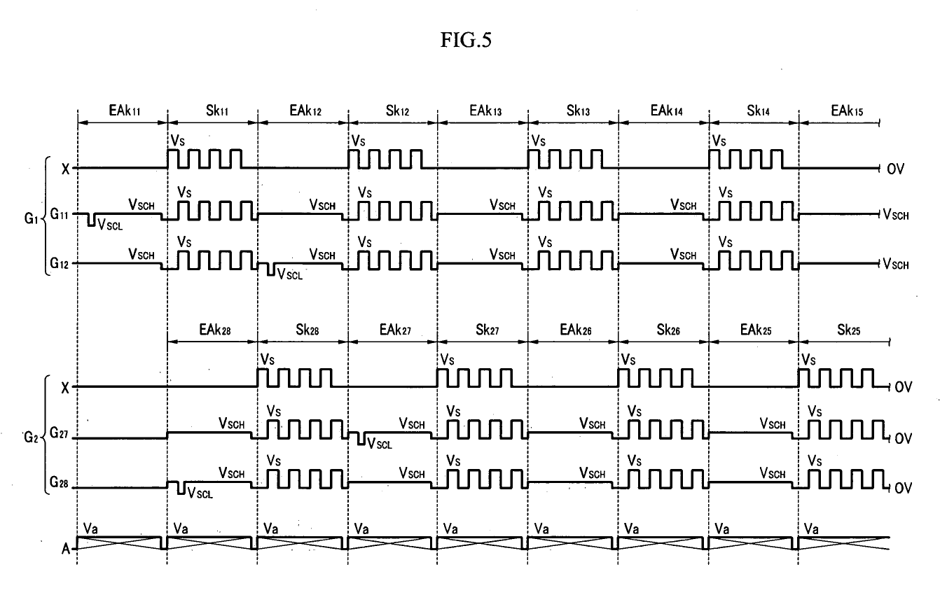

A driving waveform used in the driving method of the plasma display device according to the first exemplary embodiment of the present invention is described in detail with reference to FIG. 5.

FIG. 5 illustrates a driving waveform of a plasma display device according to a driving method of FIG. 3. In FIG. 5, for convenience of description, the first and second subgroups G₁₁ and G₁₂ of the first row group G₁, and the seventh and eighth subgroups G₂₇ and G₂₈ of the second row group G₂ are illustrated for the one subfield SFk.

As shown in FIG. 5, during the address period EAk₁₁ of the first subgroup G₁₁ of the k-th subfield SFk of the first row group G₁, a scan pulse having the voltage of V_{SCL} is applied to a plurality of Y electrodes of the first subgroup G₁₁ while a reference voltage (0V voltage in FIG. 5) is applied to the X electrodes of the first row group G₁. At this time, the address pulse having a voltage Va is applied to the A electrodes of the cells to be selected as the non-light emitting cells from among the light emitting cells formed by the Y electrodes applied with the scan pulse. In addition, a voltage V_{SCH} that is greater than the voltage V_{SCL} is applied to the Y electrodes in the first row group G₁ to which no scan pulse is applied, and the reference voltage is applied to the A electrodes to which no address pulse is applied. An erase discharge is generated in the light emitting cell to which the scan pulse having the voltage V_{SCL} and the address pulse having the voltage the voltage Va are applied, thereby erasing wall charges formed at the X electrodes and the Y electrodes and setting the discharge cell to be a non-light emitting cell.

As shown in FIG. 5, and referring again to FIG. 1, the scan pulse having the voltage V_{SCL} is applied to one Y electrode in the address period EAk₁₁, and the scan electrode driver 400 sequentially selects the Y electrode to which the scan pulse will be applied from among a plurality of Y electrodes in to the first subgroup G₁₁ in the address period EAk₁₁. For example, when driven individually, the Y electrodes may be selected in the order of their arrangement in the vertical direction. When a Y electrode is selected, the address electrode driver 300 selects a light emitting cell from among the discharge cells formed by the corresponding Y electrode. That is, the address electrode driver 300 selects a cell to which an address pulse with the voltage Va will be applied from among the A electrodes A1 to Am.

During the sustain period Sk₁₁ of the first subgroup G₁₁, the sustain pulse having a high-level voltage, e.g., a voltage Vs in FIG. 5, and a low-level voltage, e.g., 0V in FIG. 5, may be applied in inverse phases to the plurality of X electrodes of the first row group G₁ and the Y electrodes of the first to eighth subgroups G₁₁ to G₁₈. Accordingly, the light emitting cells of the first subgroup G₁₁ are sustain-discharged. That is, the voltage 0V is applied to the X electrode while the voltage Vs is applied to the Y electrode, and the voltage 0V is applied to the Y electrode while the voltage Vs is applied to the X electrode. At this time, the cells having undergone no erase discharge during the address period EAk₁₁ among the cells of the light emitting cell state of just before the subfield SF(k−1) are in the light emitting cell state, and accordingly, such a light emitting cell is sustain-discharged.

Then, during the address period EAk₁₂ of the second subgroup G₁₂, the scan pulse of the voltage V_{SCL} is sequentially applied to the plurality of Y electrodes of the second subgroup G₁₂ while the reference voltage is applied to the X electrodes of the first row group G₁, and the address pulse having the voltage Va is applied to the A electrodes of the cells to be selected as the non-light emitting cells among the light emitting cells formed by the Y electrodes applied with the scan pulse.

The sustain pulse is applied in inverse phases to the plurality of X electrodes of the first row group G₁ and the Y electrodes of the first to eighth subgroups G₁₁ to G₁₈ during the sustain period Sk₁₂, and accordingly, the light emitting cells are sustain-discharged. In such a manner, the address periods EAk₁₃ to EAk₁₈ and the sustain periods Sk₁₃ to Sk₁₈ are performed for the other subgroups G₁₃ to G₁₈.

The address period EAk₂₈ of the eighth subgroup G₂₈ is performed in the second row group G₂, while the sustain period Sk₁₁ of the first subgroup G₁₁ is performed in the k-th subfield SFk of the first row group G₁.

At the k-th subfield SFk of the second row group G₂, during the address period EAk₂₈ of the eighth subgroup G₂₈, the plurality of Y electrodes of the eighth subgroup G₂₈ are sequentially applied with a scan pulse of a voltage V_{SCL} while the X electrodes of the second row group G₂ are applied with a reference voltage, and the address pulse having the voltage Va is applied to the A electrodes of the cells to be selected as the non-light emitting cells from among the light emitting cells formed by the Y electrodes applied with the scan pulse. During the sustain period Sk₂₈, the sustain pulse is applied in inverse phases to the plurality of X electrodes of the second row group G₂ and the Y electrodes of the first to eighth subgroups G₂₁ to G₂₈ of the second row group G₂, and accordingly, the light emitting cells are sustain-discharged.

At this time, the address period EAk₁₂ of the second subgroup G₁₂ is performed at the first row group G₁ while the sustain period Sk₂₈ is performed at the k-th subfield SFk of the second row group G₂. In such a manner, the address periods EAk₂₇ to EAk₂₁ and the sustain periods Sk₂₇ to Sk₂₁ are performed for other subgroups G₂₇ to G₂₁.

As such, according to a first exemplary embodiment of the present invention, the address period for one row group G₂ or G₁ is performed concurrently with the sustain period for the other row group G₁ or G₂. That is, while the sustain discharge is generated between the plurality of X and Y electrodes of the first row group G₁ when the plurality of Y electrodes of the first row group G₁ are applied with the voltage Vs and the plurality of X electrodes are applied with the voltage 0V or the plurality of X electrodes of the first row group G₁ are applied with the voltage Vs and the plurality of Y electrodes are applied with the voltage 0V, the address pulse may be applied to the A electrodes of the cells to be selected as the non-light emitting cells in any one subgroup EAk₂ᵢ of the second group G₂.

Likewise, while the sustain discharge is generated between the plurality of X and Y electrodes of the second row group G₂ when the plurality of Y electrodes of the second row group G₂ are applied with the voltage Vs and the plurality of X electrodes are applied with the voltage 0V or the plurality of X electrodes of the second row group G₂ are applied with the voltage Vs and the plurality of Y electrodes are applied with the voltage 0V, the address pulse may be applied to the A electrodes of the cells to be selected as the non-light emitting cells in any one subgroup EAk₁ᵢ of the second group G₁. As such, if the sustain discharge is generated between the plurality of X and Y electrodes of the first row group G₁ or between the plurality of X and Y electrodes of the second row group G₂, the address pulse is applied to the A electrodes while the wall charges are re-positioned on the electrodes, and accordingly, few ions are accumulated on the A electrodes due to the address pulse. Accordingly, the weak erase discharge may occur or the erase discharge may not occur.

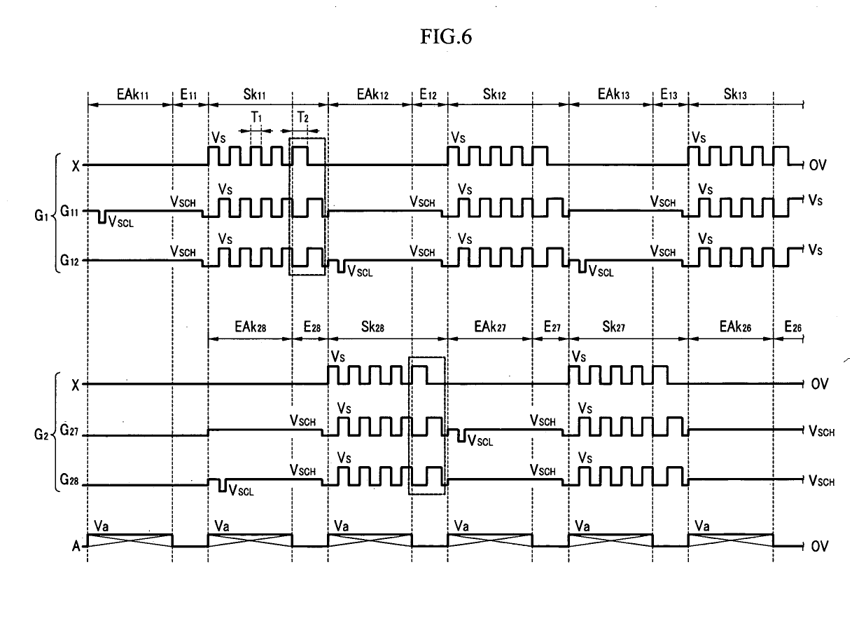

A waveform for stably generating such an erase discharge according to an exemplary embodiment is described in detail with reference to FIG. 6. FIG. 6 illustrates a different driving waveform of a plasma display from a driving waveform of FIG. 5.

As shown in FIG. 6, during each first period E₁₁ to E₁₈ and E₂₁ to E₂₈ consecutive to each address period EAk₁₁to EAk₁₈, and EAk₂₁ to EAk₂₈ of the plurality of subgroups G₁₁ to G₁₈, G₂₁ to G₂₈ at the k-th subfield SFk, the reference voltage may be applied to the plurality of A electrodes and at least one sustain pulse may be applied to the plurality of X electrodes and/or the plurality of Y electrodes of the first row group G₁. FIG. 6 illustrates the k-th subfield SFk among the plurality of subfields SF1 to SFk for convenience. In FIG. 6, during the first period E₁₁ consecutive to the address period EAk₁₁ of the first subgroup G₁₁ of the first row group G₁, the sustain pulse is not applied to the plurality of X electrodes and/or the plurality of Y electrodes of the first row group G₁, but may be applied to the plurality of X electrodes and/or the plurality of Y electrodes of the first row group G₁ during the first period E₁₁ when another subfield is provided just before the k-th subfield SFk. That is, during the first periods E₁₂ to E₁₈ consecutive to each address period EAk₁₁ to EAk₁₈ of the first row group G₁, the reference voltage or a voltage V_{SCH} may be applied to the plurality of Y electrodes of the plurality of subgroups G₂₁ to G₂₈ while at least one sustain pulse is applied to the plurality of X electrodes and/or the plurality of Y electrodes of the first row group G₁. Likewise, during the first periods E₂₁ to E₂₈ consecutive to each address period EAk₂₁ to EAk₂₈ of the plurality of subgroups G₂₁ to G₂₈ of the second row group G₂, the reference voltage or voltage V_{SCH} may be applied to the plurality of Y electrodes of the plurality of subgroups G₁₁ to G₁₈ of the first row group G1 while at least one sustain pulse is applied to the plurality of X electrodes and/or the plurality of Y electrodes of the second row group G₂. A width T2 of the sustain pulse applied during the first periods E₁₁ to E₁₈ and E₂₁ to E₂₈ may be longer than a width T₁ the sustain pulse applied during the address periods EAk₁₁ to EAk₁₈ and EAk₂₁ to EAk₂₈. With such an operation, many positive ions are formed on the A electrodes, and accordingly, the next erase discharge may stably occur.

According to a first exemplary embodiment of the present invention, a strong reset discharge is performed to initialize all the discharge cells during the reset period R and set a light emitting cell state. In this case, the contrast ratio may be deteriorated, since a black screen may appear bright. In addition, it may be difficult to form enough wall charges to set all the discharge cells as light emitting cells with only the reset period R.

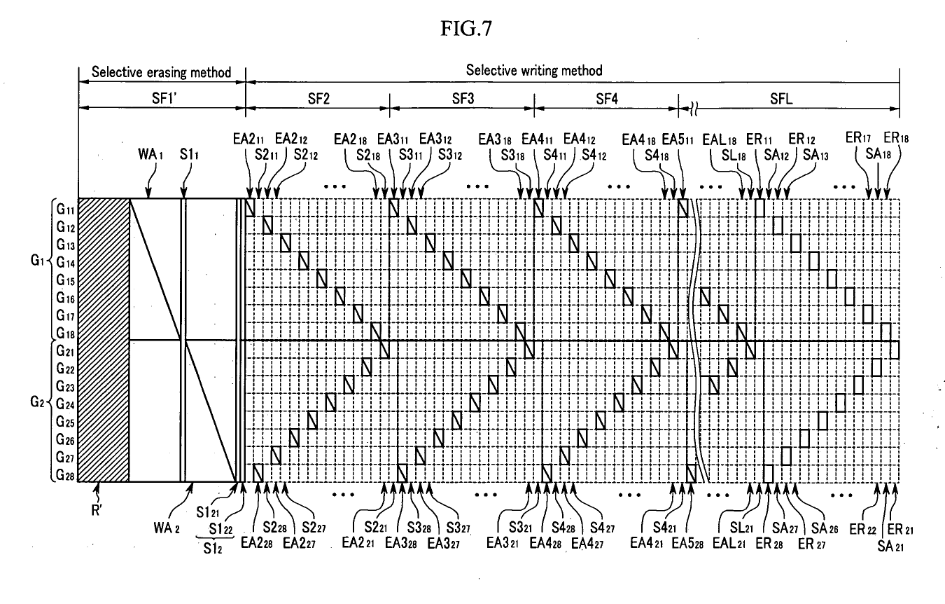

A method for stably generating an erase discharge and improving the contrast ratio is described in detail with reference to FIG. 7. FIG. 7 schematically illustrates a driving method of a plasma display device according to a second exemplary embodiment of the present invention.

As illustrated in FIG. 7, the driving method according to the second exemplary embodiment of the present invention is similar to the driving method according to the first exemplary embodiment. However, unlike in the first exemplary embodiment, the selective write method is used during address periods WA₁ and WA₂ of a first subfield SF1′. Since the address period WA₁ or WA₂ of the subfield SF1′ use the selective write method, a reset period R′ may be provided in which the light emitting cells are initialized into the non-light emitting cells during the reset period R′ immediately before the address period WA₁ or WA₂. That is, discharge cells may be initialized to be in the non-light emitting cell state during the reset period R′ immediately before the address period WA₁ or WA₂, in contrast to the first exemplary embodiment of the present invention, in which discharge cells are initialized to be in the light emitting cell state in the reset period R immediately before the address periods EA1₁₁ to EAL₁₈ and EA1₂₁ to EAL₂₈.

In order to initialize a discharge cell as a non-light emitting cell during the reset period R′ of the first subfield SF′, the reset period R′ may be realized by gradually increasing and then gradually decreasing a voltage. For example, the voltage of the plurality of Y electrodes is gradually increased and then gradually decreased during the reset period R′. While the voltage at the Y electrode is increased, a weak reset discharge is generated between the Y electrode and the X electrode to form wall charges in the discharge cell. While the voltage at the Y electrode is decreased, a weak reset discharge is generated between the Y electrode and the X electrode to erase the wall charges formed in the discharge cell. Hence, the discharge cell is reset to be a non-light emitting cell. As a result, no strong discharge is generated in the reset period R′, thereby enhancing the contrast ratio.

During the address period WA₁ of the first subfield SF1′, the write discharge is generated in the discharge cells to be set as the non-light emitting cells among the discharge cells of the first row group G₁, and accordingly the wall charges are generated. Then, during the sustain period S1₁, the sustain discharge is generated in the light emitting cells of the first row group G₁. During the sustain period S1₁, a minimum of sustain discharges, e.g., one or two sustain discharges, may occur.

During the address period WA₂ of the first subfield SF1′, the write discharge is generated in the discharge cells to be set as the non-light emitting cells among the discharge cells of the second row group G₂, and accordingly the wall charges are generated. Then, during a partial period S1₂₁ of the sustain period S1₂, the light emitting cells of the first and second row groups G₁ and G₂ are sustain-discharged. In addition, during another partial period S1₂₂ of the sustain period S1₂, the sustain discharge is not generated in the light emitting cells of the first row group G₁ but rather in the second row group G₂ while the sustain discharge is not generated in the light emitting cells of the first row group G₁ but rather in the light emitting cells of the second row group G₂. In this instance, the number of sustain discharges to be generated in the light emitting cells of the second row group G₂ during the partial period S1₂₂ of the sustain period S1₂ is set to equal the number of sustain discharges in the light emitting cells of the first row group G₁ during the sustain period S1₂.

When the weight value of the first subfield SF1′ is not expressed by the two sustain periods S1₁ and S1₂, the light emitting cells of the first and second row groups G₁ and G₂ may be the additionally sustain discharged during the partial period S1₂₂ of the sustain period S1₂.

In such a manner, the wall charges may be sufficiently formed on the respective electrodes of the light emitting cells before the subfields SF2 to SFL are addressed using the selective erase method.

Meanwhile, in FIG. 3 and FIG. 7, at the last subfield SFL of one field, the erase periods ER1₁₂ to ER1₁₈ and ER1₂₂ to ER1₂₈ and the additional sustain periods SA₁₂ to SA₁₈ and SA₂₂ to SA₂₈ of the first and second row groups G₁ and G₂ may be present or may be omitted. When the erase periods ER1₁₂ to ER1₁₈ and ER1₂₂ to ER1₂₈ and the additional sustain periods SA₁₂ to SA₁₈ and SA₂₂ to SA₂₈ are omitted, the addressing order of the respective subgroups G₁₁ to G₁₈ and G₂₁ to G₂₈ among the respective groups G₁ and G₂ over the plurality of fields may be changed. Hence, the number of sustain discharges of the respective row groups may be the same.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, according to the exemplary embodiments of the present invention, a plurality of row electrodes are divided into first and second row groups, and row electrodes of the respective row groups are again divided into a plurality of subgroups. The address periods are performed in the respective subgroups of the respective first and second row groups at the respective subfields of the one field, and the sustain periods are performed between the address periods of respective subgroups.

The address periods may be performed in the respective subgroups of the second row group while the sustain periods are performed in the respective subgroups of the first row group, and the sustain periods may be performed in the respective subgroups of the first row group while the address periods are performed in the respective subgroups of the second row group. Since the priming particles formed during the sustain period are sufficiently used during the address period, in that the address periods are disposed between the sustain periods of the respective subgroups, the width of the scan pulse may be decreased to thereby increase the speed of the scan and the sustain period during the address period, thereby reducing the length of the subfield, since the sustain period may be performed during the address period.

In addition, the erase discharge may stably occur when a constant voltage is applied to a plurality of row electrodes during the first period consecutive to the address period of each subgroup of the first row group and then at least one subgroup of the corresponding second group is sustain-discharged while a constant voltage is applied to a plurality of row electrodes during the second period consecutive to the address period of each subgroup of the second row group, and then at least one subgroup of the corresponding second group is sustain-discharged.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for driving a plasma display device having a plurality of row electrodes, a plurality of column electrodes, and a plurality of discharge cells defined by the plurality of row and column electrodes, wherein one field is divided into a plurality of subfields, the driving method comprising, at each of a plurality of consecutive first subfields:
dividing the plurality of row electrodes into a first row group and a second row group, dividing the first row group into a plurality of first subgroups, and dividing the second row group into a plurality of second subgroups;
during a first address period of each first subgroup, selecting non-light emitting cells from among the first subgroup of light emitting cells and sustain-discharging at least one second subgroup of light emitting cells from among the plurality of second subgroups;
during a first period consecutive to the first address period, applying a first voltage to the plurality of column electrodes and sustain-discharging the at least one second subgroup of light emitting cells;
during a second address period of each second subgroup, selecting non-light emitting cells among the second subgroup of light emitting cells and sustain-discharging at least one first subgroup of light emitting cells from among the plurality of first subgroups; and
during a second period consecutive to the second address period, applying the first voltage to the plurality of column electrodes and sustain-discharging the at least one first subgroup of light emitting cells.

2. The driving method as claimed in claim 1, wherein:
the plurality of row electrodes respectively includes a plurality of first electrodes and a plurality of second electrodes;
the sustain-discharging the light emitting cells during the first and second address periods includes applying at least one first sustain pulse alternately having a first high level voltage and a first low level voltage, and applying at least one second sustain pulse alternately having a second high level voltage and a second low level voltage, the second sustain pulse having an inverse phase with respect to the first sustain pulse; and
the sustain-discharging the light emitting cells during each of the first and second periods includes applying a third high level voltage to the first electrodes of the light emitting cells, the third high level voltage being applied for longer than the first high level voltage.

3. The driving method as claimed in claim 2, wherein the sustain-discharging the light emitting cells during each of the first and second periods further comprises applying a fourth high level voltage to the second electrodes of light emitting cells, the fourth high level voltage being applied for longer than the second high level voltage.

4. The driving method as claimed in claim 1, wherein during the first and second address periods, applying a voltage higher than the first voltage to column electrodes of the light emitting cells selected as the non-light emitting cells.

5. The driving method as claimed in claim 1, further comprising, during second subfields prior to the plurality of first subfields:
selecting light emitting cells from among the first row group of discharge cells and sustain-discharging the first row group of light emitting cells; and
selecting light emitting cells from among the second row group of discharge cells and sustain-discharging the second row group of light emitting cells.

6. The driving method as claimed in claim 5, further comprising, during the second subfields, setting the plurality of discharge cells as non-light emitting cells before selecting the light emitting cells from among the first row group of discharge cells.

7. The driving method as claimed in claim 6, wherein, during the second subfields, the first row group of light emitting cells is not sustain-discharged during some part of the period for sustain-discharging the second row group of light emitting cells.

8. The driving method as claimed in claim 7, wherein, during the second subfields, during periods other than those for sustain-discharging the second row group of light emitting cells, the first row group of light emitting cells is sustain-discharged.

9. A plasma display, comprising:
a plasma display panel including a plurality of row electrodes, a plurality of column electrodes, and a plurality of discharge cells respectively defined by the row and column electrodes;
a controller for dividing one field into a plurality of subfields, dividing the plurality of row electrodes into first and second row groups, dividing the first row group into a plurality of first subgroups, and dividing the second row group into a plurality of second subgroups; and
a driver for driving the plurality of row electrodes and the plurality of column electrodes,
wherein, at each of the plurality of consecutive first subfields,
the driver sequentially applies a scan pulse to the each first subgroup during a second period among a first period of each first subgroup and sustain-discharges at least one second subgroup of light emitting cells among the plurality of second subgroups,
during a third period among the first period, the driver applies a voltage higher than that of the scan pulse to each first subgroup and sustain-discharges the at least one second subgroup of light emitting cells,
during a fifth period among a fourth period of each second subgroup, the fifth period being between consecutive first periods, the driver sequentially applies a scan pulse to each second subgroup and sustain-discharges at least one first subgroup of light emitting cells among the plurality of first subgroups, and
during a sixth period among the fifth period, the driver applies a voltage higher than that of the scan pulse to each second subgroup and sustain-discharges the at least one first subgroup of light emitting cells.

10. The plasma display as claimed in claim 9, wherein:
the plurality of row electrodes respectively includes a plurality of first electrodes and a plurality of second electrodes,
the driver applies at least one sustain pulse having the first voltage and a second voltage lower than the first voltage to the first and second electrodes of the light emitting cells in an inverse phase during the second and fifth periods, and applies a third voltage higher than the second voltage to the first electrodes of the light emitting cells during the third and sixth periods, and
a period for applying the third voltage to the first electrodes is longer than a period for applying the first voltage to the first electrodes.

11. The plasma display as claimed in claim 10, wherein the driver applies a fourth voltage higher than the second voltage to the second electrodes of the light emitting cells during the third and sixth periods, and a period for applying the fourth voltage to the second electrode is longer than a period for applying the first voltage to the second electrode.

12. The plasma display as claimed in claim 9, wherein the driver applies a fifth voltage to column electrodes of the light emitting cells to be selected as non-light emitting cells among light emitting cells formed by the plurality of column electrodes applied with the scan pulse during the second and fifth periods, and applies a voltage lower than the fifth voltage to the plurality of column electrodes during the third and sixth periods.

13. The plasma display as claimed in claim 9, wherein, during second subfields prior to the plurality of first subfields, the driver selects light emitting cells from among the first row group of discharge cells and sustain-discharges the first row group of light emitting cells, and selects light emitting cells from among the second row group of discharge cells and sustain-discharges the second row group of light emitting cells.

14. The plasma display as claimed in claim 13, further comprising, during the second subfields, the driver sets the plurality of discharge cells as non-light emitting cells before selecting the light emitting cells from among the first row group of discharge cells.

15. The plasma display as claimed in claim 14, wherein, during the second subfields, the driver does not sustain-discharge the first row group of light emitting cells during some part of the period for sustain-discharging the second row group of light emitting cells.

16. The plasma display as claimed in claim 15, wherein, during the second subfields, during periods other than those for sustain-discharging the second row group of light emitting cells, the first row group of light emitting cells is sustain-discharged.
